(19) United States
(12) Patent Application Publication
(10) Pub. No.: US 2015/0237312 A1
(43) Pub. Date: Aug. 20, 2015

(54) REMOTE VIDEO SURVEILLANCE APPARATUS AND SYSTEM

(71) Applicant: Wolfgang Reger, Calgary (CA)

(72) Inventor: Wolfgang Reger, Calgary (CA)

(21) Appl. No.: 14/182,476

(22) Filed: Feb. 18, 2014

(51) Int. Cl. H04N 7/18; H04N 5/225; H04N 5/232

(52) U.S. Cl. CPC H04N 7/185; H04N 5/23241; H04N 5/2252

(57) ABSTRACT

A remote video surveillance apparatus is provided, including a main housing comprising a main box and a main lid, a camera housing comprising a camera box and a camera lid, a support post having a top end and a bottom end, at least one external power device, at least one battery, at least one camera, at least one data transmission device, a power over ethernet switch, a charge controller; wherein the main box is affixed to the support post at said bottom end, wherein the camera box is affixed to the support post at the top end, wherein the support post restricts movement of an edge of the main lid, wherein the at least one battery, the power over ethernet switch, and the charge controller are positioned within the main box, and wherein the at least one external power device and the at least one battery are electrically connected to said charge controller.

### FIELD OF THE INVENTION

The present invention relates generally to surveillance apparatuses, and more particularly, relating to remote video surveillance apparatuses.

### BACKGROUND OF THE INVENTION

Remote video surveillance apparatuses are useful for monitoring non-permanent locations such as oil drilling rigs, event locations, and constructions sites. Remote video surveillance apparatuses are generally attached to a trailer for portability and include a raised camera location to resist vandalism. Power for remote video surveillance apparatuses is usually provided by a generator, a battery, or a connection to external AC power.

Remote video surveillance apparatuses normally include a storage system to record data, such as a DVR. The remote video surveillance system may also be connected to an external internet connection to transfer data to a remote storage system. Alternatively, it is known for a remote video surveillance apparatus to export data through a cellular network to allow for remote storage of the data.

While the apparatuses heretofore fulfill their respective, particular objectives and requirements, they do not provide a standalone remote video surveillance apparatus which may be quickly deployed but resists tampering and provides real-time external data transmission as such there exists a need for a remote video surveillance apparatus, which substantially departs from the prior art, and in doing so provides an apparatus primarily developed for the purpose of providing real-time external data transmission from a standalone a quickly deployable surveillance apparatus.

### SUMMARY OF THE INVENTION

In view of the foregoing disadvantages inherent in the known types of remote video surveillance apparatuses including support structure designs and communication systems now present in the prior art, the present invention provides a new remote video surveillance apparatus wherein the remote video surveillance system may be used independently or as part of a connected system.

In accordance with the present invention, a remote video surveillance apparatus, allows surveillance of a remote location while transmitting data to a central recording location through a communication device.

In general, in one aspect, a remote video surveillance apparatus is provided. The remote video surveillance apparatus includes a main housing comprising a main box and a main lid, a camera housing comprising a camera box and a camera lid, a support post having a top end and a bottom end, at least one external power device, at least one battery, at least one camera, at least one data transmission device, a power over ethernet switch, a charge controller; wherein the main box is affixed to the support post at said bottom end, wherein the camera box is affixed to the support post at the top end, wherein the support post restricts movement of an edge of the main lid, wherein the at least one battery, the power over ethernet switch, and the charge controller are positioned within the main box, and wherein the at least one external power device and the at least one battery are electrically connected to said charge controller.

In general, in another aspect, a remote video surveillance system is provided. The remote video surveillance system includes two or more remote video surveillance apparatuses; wherein each video surveillance apparatus includes a main housing comprising a main box and a main lid, a camera housing comprising a camera box and a camera lid, a support post having a top end and a bottom end, at least one external power device, at least one battery, at least one camera, at least one data transmission device, a power over ethernet switch, a charge controller, wherein the main box is affixed to the support post at the bottom end, wherein the camera box is affixed to the support post at the top end, wherein the support post restricts movement of an edge of said main lid, wherein the at least one battery, the power over ethernet switch, and the charge controller are positioned within the main box, wherein the at least one external power device and the at least one battery are electrically connected to the charge controller; and wherein each of the two or more remote video surveillance apparatuses is connected to at least one of the two or more remote video surveillance apparatuses through the at least one data transmission device.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a front view of the remote video surveillance apparatus constructed in accordance with the principles of the present invention;

FIG. 2 is a left side view of the remote video surveillance apparatus;

FIG. 3 is a rear view of the remote video surveillance apparatus;

FIG. 4 is a left side view of the main box lid;

FIG. 5 is a front view of the main box lid;

FIG. 6 is a top view of the main box, illustrating arrangement of the batteries and the power over ethernet switch;

FIG. 7 is a cross-sectional view of the main box, showing the shelf for storage of the power over ethernet switch;

FIG. 8 is a front view of the remote video surveillance apparatus, showing a second solar panel;

FIG. 9 is a cross-sectional view of the camera box, illustrating the connection to the support post; and

FIG. 10 is a schematic view of the remote video surveillance system, illustrating the connectivity of the remote video surveillance apparatuses to a central recording location.

### DETAILED DESCRIPTION OF THE INVENTION

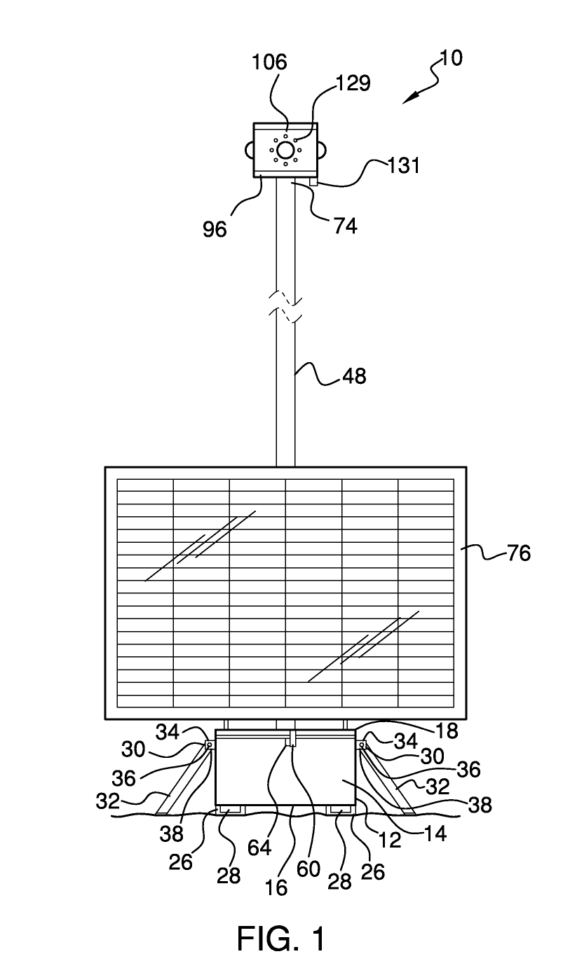

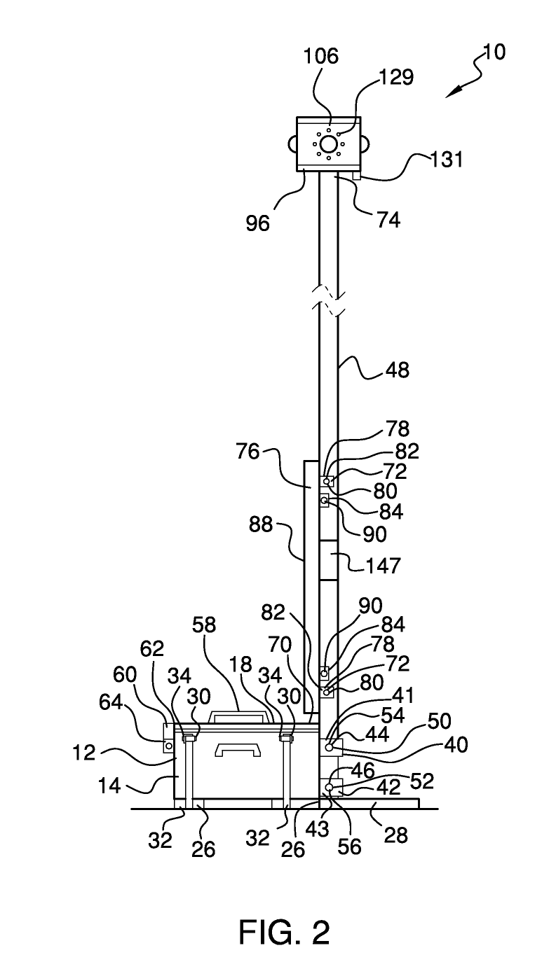

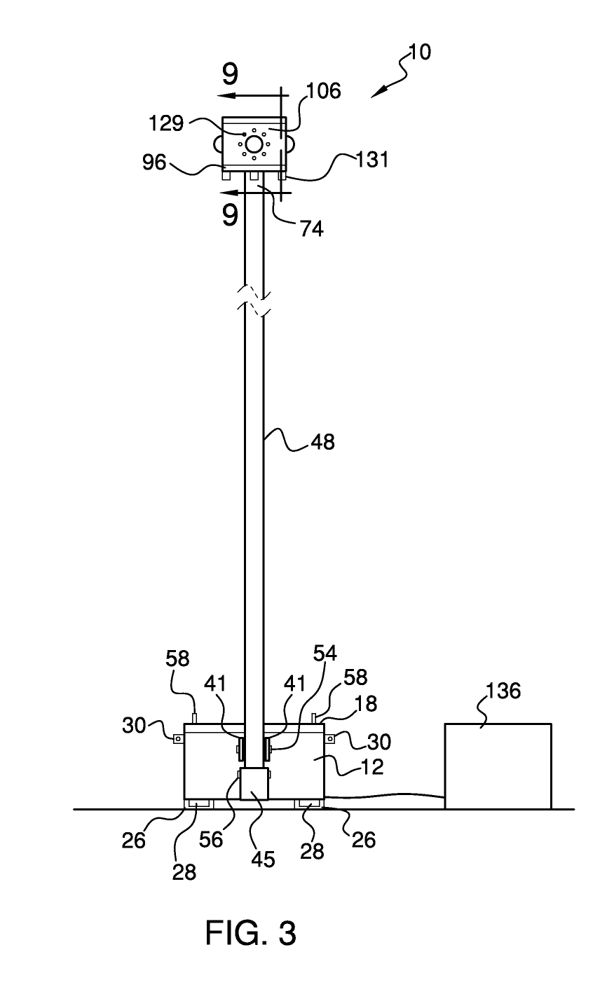

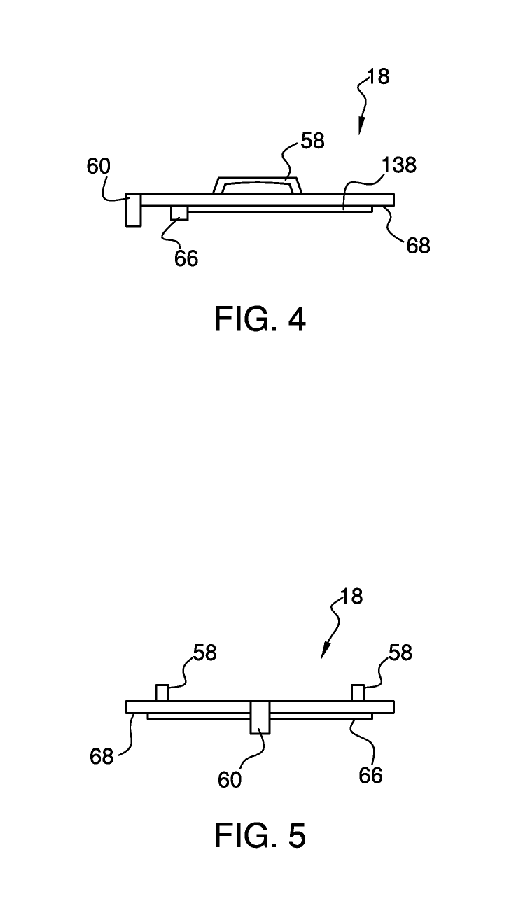

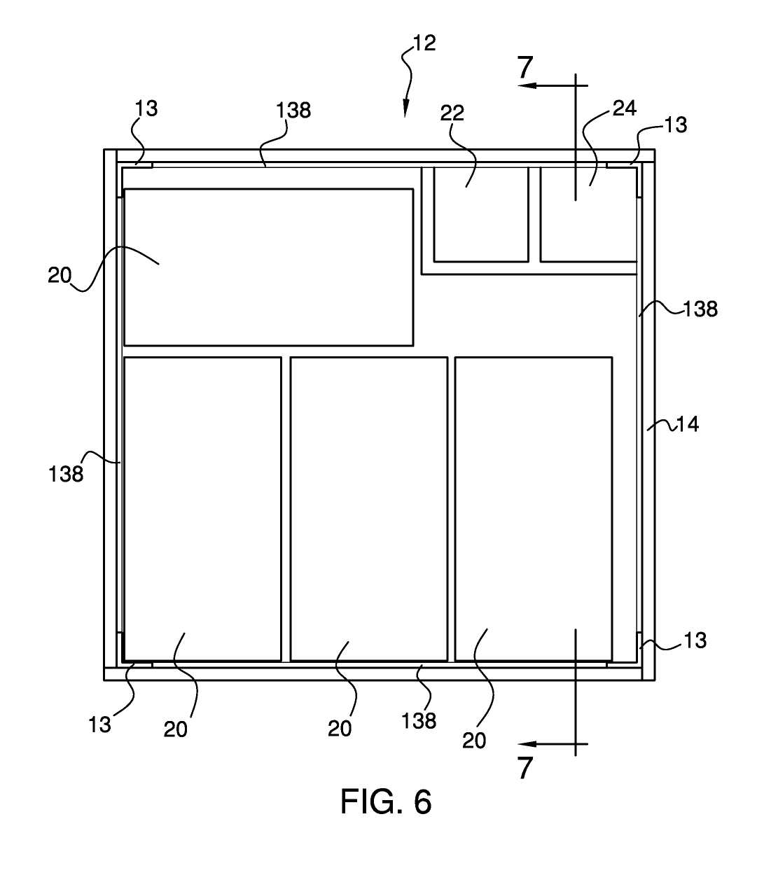

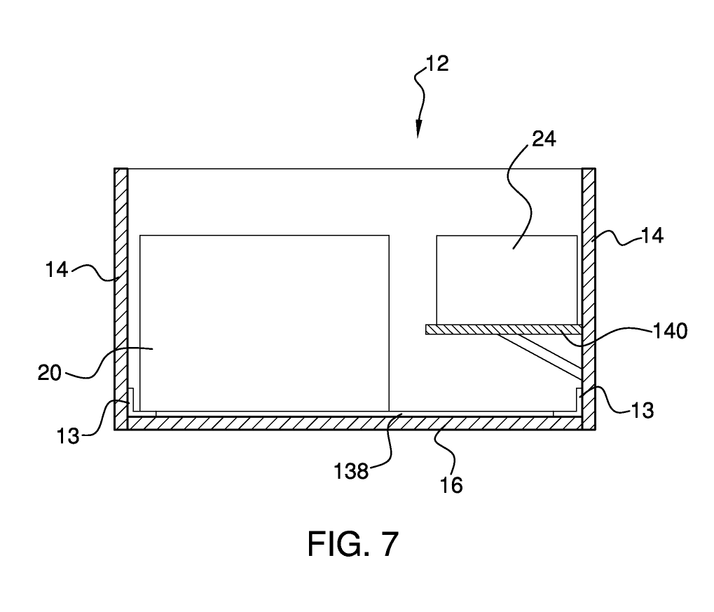

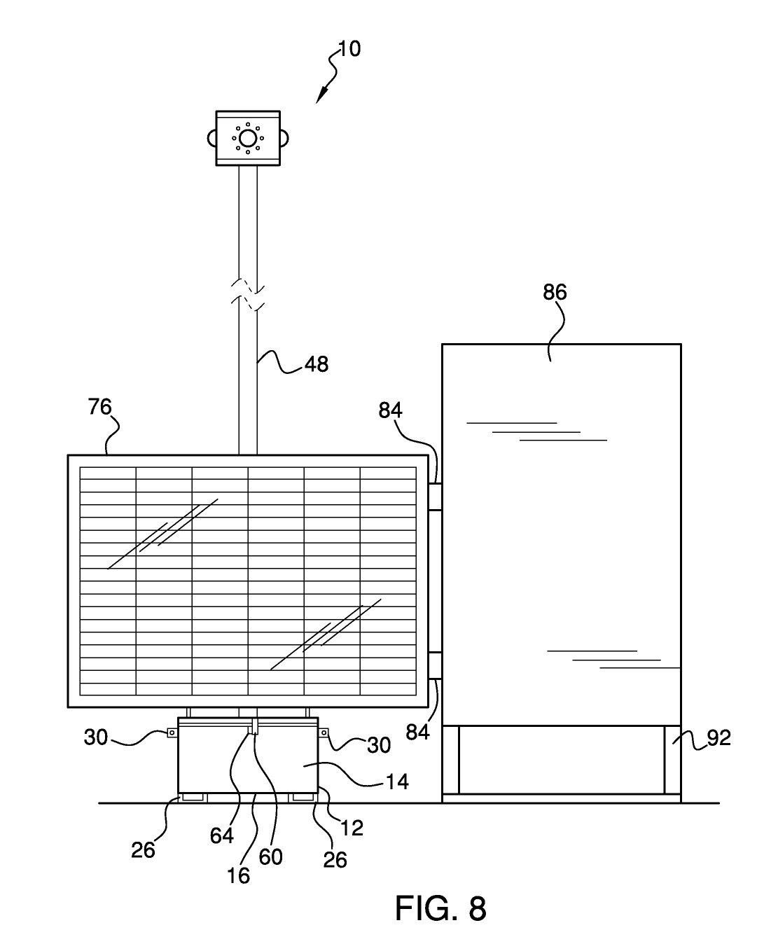

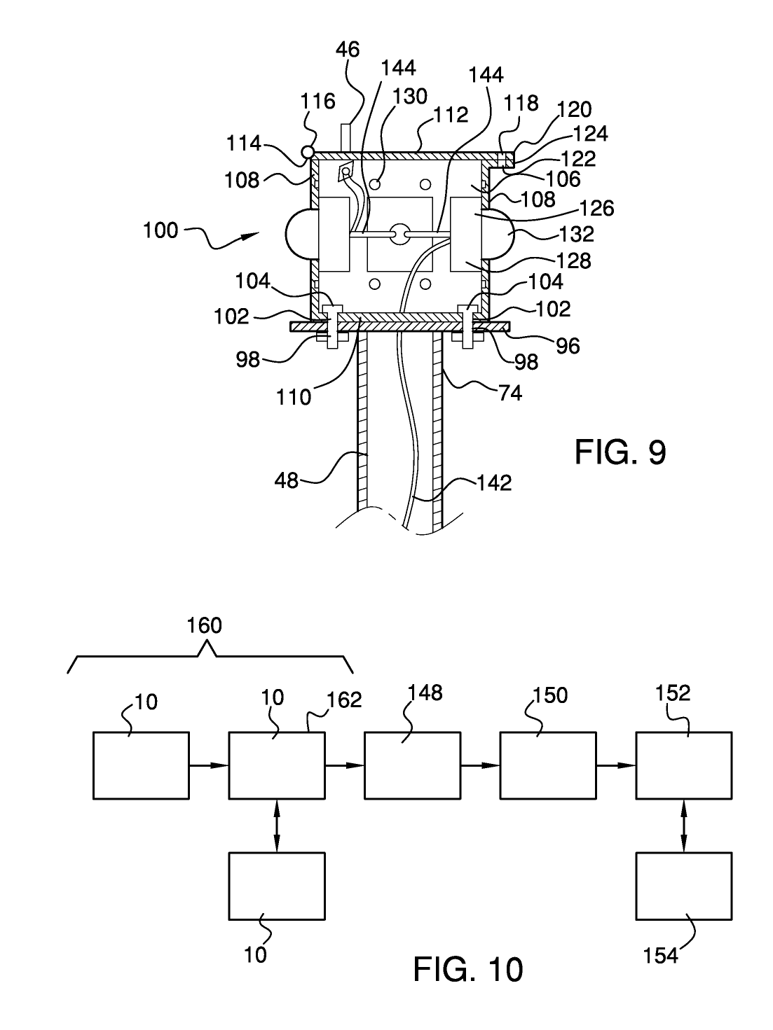

With reference to FIGS. 1 through 9, there is representatively illustrated a new remote video surveillance apparatus 10 in accordance with an embodiment of the present invention. The remote video surveillance apparatus 10 includes a main box 12 that provides a base for supporting and stabilizing the remote video surveillance apparatus 10. The main box 12 includes a frame 13, four main box side walls 14 formed in a rectangular shape, a main box floor 16 connected to the bottom edges if the four main box side walls 14 and to the frame 13, and a removable main box lid 18 which is adapted to be positioned on the top edges of the four main box side walls 14.

The four main box side walls 14, the main box floor 16, and the removable main box lid 18 are made of steel to create a heavy and stabile base for the remote video surveillance apparatus 10. Manufacturing the components of the main box 12 from steel further provides the benefit of resisting tampering. Damage from vandalism or unintentional impact from other items in the environment in which the remote video surveillance apparatus 10 is being used is also reduced by manufacturing the components of the main box 12 from steel.

Stability of the remote video surveillance apparatus 10 is achieved through providing a main box 12 that is wide enough to hold at least four twelve-volt batteries 20, a power over ethernet switch 22, and a charge controller 24. The stability is enhanced by providing four support feet 26. The support feet 26 are sized to allow a standard 2×4 wooden board 28 to be positioned within the support feet in a position that allows at least one end of the standard 2×4 wooden board 28 to protrude beyond the outer perimeter of the main box 12. Stability is further enhanced by providing strut brackets 30 to which struts 32 may be attached to provide contact with the ground at a position beyond the outer perimeter of the main box 12. The struts will be attached by fasteners 34 that protrude through holes 36 in the strut brackets 30 and holes 38 in the struts 32.

The main box 12 has an upper mount bracket 40 and a lower mount bracket 42 attached thereto. The upper mount bracket 40 includes two upper mount tabs 41 that are perpendicular to each other, protruding perpendicularly from the rear wall 14 of the main box 12. The upper mount bracket 40 has an upper mount aperture 44 positioned horizontally through the upper mount bracket 40. The lower mount bracket 42 includes two lower mount tabs 43 that are perpendicular to each other, protruding perpendicularly from the rear wall 14 of the main box 12. The lower mount tabs 43 are connected by a lower mount wall 45 that connects the two lower mount tabs 43. The lower mount bracket 42 has a lower mount aperture 46 positioned horizontally through the lower mount bracket 42.

The upper mount bracket 40 and the lower mount bracket 42 are adapted to receive a support post 48. The support post includes an upper post aperture 50 and a lower post aperture 52. The support post 48 is affixed to the upper mount bracket 40 with an upper fastener 54 which passes through the upper mount aperture 44 and the upper post aperture 50. The support post 48 is affixed to the lower mount bracket 42 with a lower fastener 56 which passes through the lower mount aperture 46 and the lower post aperture 52.

The main box lid 18 includes two lid handles 58 to aid in movement and carrying of the main box lid 18. The main box lid 18 further includes a main box lid latch 60 near its front edge 62. The main box lid latch 60 cooperates with a main box latch tab 64 which protrudes perpendicularly from the front side wall 14 of the main box 12 to allow for locking of the main box lid 18 to the front side wall 14 if the main box 12. The main box lid is further retained in position by a main box lid protrusion 66 which extends perpendicularly from the bottom face 68 of the main box lid. The main box lid protrusion 66 protrudes at least below the top surface of the main box walls 14 so that the main box lid 18 to restrict motion of the main box lid in the forward and sideways directions.

The main box lid 18 is restrained in the rearward direction by the support post 48. The support post 48 also has a lid restraint 70. The lid restraint 70 restricts movement of the rear portion of the main box lid 18 in an upward direction away from the top of the rear wall 14 of the main box 12.

The support post 48 includes solar panel mounting apertures 72 between the upper post aperture 50 and an upper end 74 of the support post 48. A solar panel 76 including solar panel mounting tabs 78 including solar panel tab apertures 80 which are adapted to align with the solar panel mounting apertures 72 to allow a fastener 82 to pass through the solar panel mounting apertures 72 and the solar panel tab apertures 80 to secure the solar panel 76 to the support post 48.

The solar panel 76 includes connection tabs 84 for connecting a second solar panel 86. The connection tabs 84 extend from the solar panel 76 in a direction parallel to the front face 88 of the solar panel 76. The connection tabs 84 include a portion that extends perpendicular to the front face 88 of the solar panel 76. The portion of the connection tabs 84 that extends perpendicular to the front face 88 of the solar panel 76 includes a first solar panel connection aperture 90 for receiving a fastener to affix the connection tab to the second solar panel 86.

The second solar panel 86 includes a support frame 92. The support frame 92 includes second solar panel connection apertures 94 which are adapted to receive the fastener used for affixing the second solar panel 86 to the connection tabs 84.

The upper end 74 of the support post 48 includes a mounting flange 96 the mounting flange includes flange apertures 98 which are positioned vertically through the mounting flange 96. A camera housing 100 is affixed to the mounting flange 96 through camera housing mount apertures 102. The camera housing mount apertures 102 are adapted to cooperate with the flange apertures 98 so a fastener 104 can pass through the camera housing mount apertures 102 and the flange apertures 98 to affix the camera housing 100 to the mounting flange 96.

The camera housing 100 includes a camera box 106 which includes 4 camera box walls 108 in a rectangular shape, a camera box floor 110 affixed to the camera box walls 108, and a camera box lid 112. One of the camera box walls 108 includes a first hinge portion 114. The camera box lid includes a second hinge portion 116. The first hinge portion 114 and the second hinge portion 116 cooperate to allow the camera box lid 112 to rotate around the hinge portions.

The camera box lid 112 includes a lid locking aperture 118 near the edge 120 opposite from the second hinge portion 114. The lid locking aperture 118 goes vertically through the camera box lid 112. The camera box 106 has a camera box locking aperture 122 through a camera box locking tab 124. The camera box locking aperture 122 is adapted to align with the lid locking aperture 118 in when the camera box lid 118 is in the closed position, meaning the lid is laid flat against the upper edges of the camera box walls 108.

The camera box 106 includes four mounting locations 126 for cameras 128. The cameras 128 are internet protocol cameras. The mounting locations 126 will include a plurality of mounting holes 130 adapted to accommodate various types of cameras 128. Each camera 128 is mounted on a camera box wall 108 so the lens of the camera 128 faces outward from the camera box 106. The camera box walls 108 have transparent coverings 132 over camera lens apertures 134 which allow for a clear view for the camera lens.

The camera box 106 may also include one or more lights 129 to aid the performance of the camera 128 in low ambient light conditions. The one or more lights 129 will preferably be light emitting diode (LED) lights. The one or more lights 129 will also preferably be connected to a motion detector 131 so that power will only be supplied to the one or more lights 129 when motion is detected, to limit power consumption by the one or more lights 129.

Electrical power for the remote video surveillance apparatus 10 is stored in the batteries 20. The batteries 20 are in an arrangement that provides a forty-eight volt output. The batteries 20 are electrically connected to the charge controller 24. The charge controller 24 controls the electrical power provided to or taken from the batteries 20 to maintain a proper operating charge level.

The charge controller 24 is also electrically connected to the external power source which may be any or all of the solar panel 76, the second solar panel 86, and a fuel cell 136. The fuel cell 136 will preferably be a methanol fuel cell or a hydrogen fuel cell. The choice of external power source will depend on the environment in which the remote video surveillance apparatus 10 is to be used. For example, surveillance at an event site which is to be for a short duration may only require power from the batteries and may require no external power source. A remote drilling or construction site on the other hand may be under surveillance for a long period of time in which case all of the solar panel 76, the second solar panel 86, and a fuel cell 136 would provide the most secure power delivery to sustain operation throughout the duration of the surveillance with the minimal amount of maintenance required. The amount of sun available at a particular location will also be considered in choosing the optimal external power source.

Rigid insulation 138 is provided on the inside main box walls 14, on the inside of the main box lid 18, and on top of the main box floor 16. The rigid insulation 138 insulates the interior of the main box 12 from extreme heat or cold that could affect the performance of the electrical components within the main box 12. The interior of the main box further includes a shelf 140 for support of the power over ethernet switch 22 and the charge controller 24. The shelf keeps the power over ethernet switch 22 and the charge controller 24 off of the main box floor 16 so that these components will be kept above any standing water in the event of a water leak into the main box 12.

The power over ethernet switch 22 is also electrically connected to the charge controller 24. The power over ethernet switch 22 is also connected to at least one camera 128. The power over ethernet switch 22 provides power to the camera 128 through a cable 142. Alternatively, the cable 142 may provide power to the camera 128 directly from the charge controller 24. The cable 142 passes through a main box cable aperture in the rear main box wall 14 which aligns with a support post cable aperture in the support post 48. The cable 142 passes from the support post to the camera box 106 through a camera box cable aperture in the camera box floor 110. If more than one camera 128 is to be powered, the additional cameras 128 may be electrically connected to the other cameras 128 by connecting cables 144. Alternatively, additional cables 142 may be provided through the support post 48 for direct connection between the power over ethernet switch 22 and each camera 128.

Although not preferred, the camera 128 may also be directly electrically connected to the charge controller 24. Alternatively, a standard electrical switch may be utilized between the charge controller 24 and the camera 128. The standard electrical switch will be electrically connected to the charge controller 24 and the camera 128.

The cameras 128 are connected to a data transmission device 146. The data transmission device 146 may be a bluetooth transceiver, a wifi transceiver, a satellite transceiver, a radio frequency transmitter, a microwave transmitter, an infrared transmitter, or a cellular transceiver. The choice for a data transmission device 146 will depend on the connectivity of the location where the remote video surveillance apparatus 10. The data transmission device 146 may also allow connection of external devices to the internet. For example, the data transmission device 146 may function as a wifi hotspot when the data transmission device 146 is a wifi transceiver.

The power over ethernet switch 22 may also be connected to an internet protocol phone147. The internet protocol phone 147 is further connected to the data transmission device 146. The internet protocol phone 147 allows a user to place a telephone call using the connectivity of the remote video surveillance apparatus 10.

In operation, the remote video surveillance apparatus 10 is positioned in a location to be monitored. The data from the cameras 128 is transferred to the data transmission device 146. The data transmission device 146 is used to transmit data to a receiving device 148. The receiving device 148 transmits the data through the internet to a central receiving location 150. The central receiving location 150 stores the data on a tangible medium 152, such as a DVD, computer hard drive, or solid state memory. The tangible medium 152 is connected to the internet and allows a user to view and control the data stored on the tangible medium 152 using a computing device 154 connected to the internet.

More than one remote video surveillance apparatus 10 may be connected through their data transmission devices 146 to provide a remote video surveillance system 160. In operation, the remote video surveillance system 160 is positioned in a location to be monitored. The data from the cameras 128 of each remote video surveillance apparatus 10 is transferred to the transmission remote video surveillance apparatus 162. The transmission remote video surveillance apparatus 162 uses its data transmission device 146 to transmit data to a receiving device 148. The receiving device 148 transmits the data through the internet to a central receiving location 150. The central receiving location 150 stores the data on a tangible medium 152, such as a DVD, computer hard drive, or solid state memory. The tangible medium 152 is connected to the internet and allows a user to view and control the data stored on the tangible medium 152 using a computing device 154 connected to the internet.

A number of embodiments of the present invention have been described. Nevertheless, it will be understood that various modifications may be made without departing from the spirit and scope of the invention. Accordingly, other embodiments are within the scope of the following claims.

What is claimed is:

1. A remote video surveillance apparatus, comprising:
a main housing comprising a main box and a main lid;
a camera housing comprising a camera box and a camera lid;
a support post having a top end and a bottom end;
at least one external power device;
at least one battery;
at least one camera;
at least one data transmission device;
a power over ethernet switch;
a charge controller;
wherein said main box is affixed to said support post at said bottom end;
wherein said camera box is affixed to said support post at said top end;
wherein said support post restricts movement of an edge of said main lid;
wherein said at least one battery, said power over ethernet switch, and said charge controller are positioned within said main box; and
wherein said at least one external power device and said at least one battery are electrically connected to said charge controller.

2. The remote video surveillance apparatus of claim 1 wherein said at least one data transmission device is selected from a group consisting of a bluetooth transceiver; a wifi transceiver; a satellite transceiver, a radio frequency transmitter, a microwave transmitter, an infrared transmitter, or a cellular transceiver.

3. The remote video surveillance apparatus of claim 1 wherein said at least one external power device comprises a solar panel.

4. The remote video surveillance apparatus of claim 3 wherein said at least one solar panel is affixed to said support post between said top end and said bottom end.

5. The remote video surveillance apparatus of claim 1 wherein said at least one external power device comprises a fuel cell.

6. The remote video surveillance apparatus of claim 1 wherein said at least one external power device comprises a solar panel and a fuel cell.

7. The remote video surveillance apparatus of claim 1 further comprising a data cable;
wherein said main box further comprises a main box aperture;
wherein said support post further comprises a support post aperture;
wherein said main box aperture and said support post aperture cooperate to allow passage of said data cable between said main box to said support post.

8. The remote video surveillance apparatus of claim 1 wherein said main box further comprises a plurality of support legs;
wherein said support legs comprise support apertures.

9. The remote video surveillance apparatus of claim 1 wherein said main box further comprises at least one support strut.

10. The remote video surveillance apparatus of claim 1 further comprising an IP phone.

11. A remote video surveillance system comprising:
two or more remote video surveillance apparatuses;
where in each video surveillance apparatus comprises:
a main housing comprising a main box and a main lid;
a camera housing comprising a camera box and a camera lid;
a support post having a top end and a bottom end;
at least one external power device;
at least one battery;
at least one camera;
at least one data transmission device;
a power over ethernet switch;
a charge controller;
wherein said main box is affixed to said support post at said bottom end;
wherein said camera box is affixed to said support post at said top end;
wherein said support post restricts movement of an edge of said main lid;
wherein said at least one battery, said power over ethernet switch, and said charge controller are positioned within said main box;
wherein said at least one external power device and said at least one battery are electrically connected to said charge controller; and
wherein each of said two or more remote video surveillance apparatuses is connected to at least one of said two or more remote video surveillance apparatuses through said at least one data transmission device.

12. The remote video surveillance system of claim 11 wherein said at least one data transmission device is selected from a group consisting of a bluetooth transceiver; a wifi transceiver; a satellite transceiver, a radio frequency transmitter, a microwave transmitter, an infrared transmitter, or a cellular transceiver.

13. The remote video surveillance system of claim 12 wherein at least one of said two or more remote video surveillance apparatuses comprises a satellite transceiver.

14. The remote video surveillance system of claim 13 wherein only one of said two or more remote video surveillance apparatuses comprises a satellite transceiver.

15. The remote video surveillance system of claim 11 wherein said at least one external power device comprises a solar panel.

16. The remote video surveillance system of claim 15 wherein said at least one solar panel is affixed to said support post between said top end and said bottom end.

17. The remote video surveillance system of claim 11 wherein said at least one external power device comprises a fuel cell.

18. The remote video surveillance system of claim 11 wherein said at least one external power device comprises a solar panel and a fuel cell.

19. The remote video surveillance system of claim 11 further comprising a data cable;
wherein said main box further comprises a main box aperture;
wherein said support post further comprises a support post aperture;
wherein said main box aperture and said support post aperture cooperate to allow passage of said data cable between said main box to said support post.

20. The remote video surveillance system of claim 11 further comprising an IP phone.
